(19) United States
(12) Patent Application Publication
(10) Pub. No.: US 2022/0268896 A1
(43) Pub. Date: Aug. 25, 2022

(54) OPTICAL DISTANCE MEASUREMENT APPARATUS

(71) Applicant: DENSO CORPORATION, Kariya-city (JP)

(72) Inventors: Akifumi UENO, Kariya-city (JP); Teiyuu KIMURA, Kariya-city (JP); Fumiaki MIZUNO, Kariya-city (JP)

(21) Appl. No.: 17/653,098

(22) Filed: Mar. 1, 2022

Related U.S. Application Data
(63) Continuation of application No. PCT/JP2020/032874, filed on Aug. 31, 2020.

(30) Foreign Application Priority Data
Sep. 3, 2019 (JP) 2019-159995
Aug. 21, 2020 (JP) 2020-139971

(51) Int. Cl. G01S 7/481; G02B 26/08; G01S 7/497; G05D 3/12; G01S 17/42

(52) U.S. Cl. CPC G01S 7/4817; G02B 26/0816; G01S 7/497; G05D 3/127; G01S 17/42

(57) ABSTRACT

An optical distance measurement apparatus includes a casing, a light emitting unit, a mirror, a rotating unit, a light receiving unit, a window portion, and a reference angle marker. The light emitting unit emits laser light. The mirror is arranged inside the casing and reflects the laser light that is emitted from the light emitting unit. The rotating unit rotates the mirror. The light receiving unit includes a light receiving element for receiving incident light. The window portion is provided in the casing and is for emitting the laser light that is reflected by the mirror outside the casing. The reference angle marker is provided in at least either of the casing and the window portion, and is detected by the light receiving unit based on a rotation angle of the mirror being a reference rotation angle that is prescribed in advance.

### CROSS-REFERENCE TO RELATED APPLICATIONS

The present application is a continuation application of International Application No. PCT/JP2020/032874, filed on Aug. 31, 2020, which claims priority to both Japanese Patent Application No. 2019-159995, filed on Sep. 3, 2019, and Japanese Patent Application No. 2020-139971, filed on Aug. 21, 2020. The contents of these applications are incorporated herein by reference in their entirety.

### BACKGROUND

### Technical Field

The present disclosure relates to an optical distance measurement apparatus.

### Related Art

An optical distance measurement apparatus that includes a rotation angle sensor that detects a rotation angle of a mirror that reflects laser light for distance measurement, and a circuit that generates a clock signal for detecting a reference rotation angle of the mirror is known.

### SUMMARY

An aspect of the present disclosure provides an optical distance measurement apparatus that includes a casing, a light emitting unit, a mirror, a rotating unit, a light receiving unit, a window portion, and a reference angle marker. The light emitting unit emits laser light. The mirror is arranged inside the casing and reflects the laser light that is emitted from the light emitting unit. The rotating unit rotates the mirror. The light receiving unit includes a light receiving element for receiving incident light. The window portion is provided in the casing and is for emitting the laser light that is reflected by the mirror outside the casing. The reference angle marker is provided in at least either of the casing and the window portion, and is detected by the light receiving unit based on a rotation angle of the mirror being a reference rotation angle that is prescribed in advance.

### BRIEF DESCRIPTION OF THE DRAWINGS

In the accompanying drawings:

FIG. 1 is an explanatory diagram illustrating a configuration of an optical distance measurement apparatus according to a first embodiment;

FIG. 2 is an explanatory diagram illustrating a configuration of a light receiving unit;

FIG. 3 is an explanatory diagram illustrating a configuration of a reference angle marker;

FIG. 4 is a flowchart illustrating rotation-angle deviation detection control by a positional deviation detection apparatus;

FIG. 5 is an explanatory diagram illustrating a detection method for the reference angle marker;

FIG. 6 is an explanatory diagram illustrating a method for detecting the reference angle marker using signal strength distribution;

FIG. 7 is an explanatory diagram illustrating a configuration of an optical distance measurement apparatus according to a second embodiment;

FIG. 8 is an explanatory diagram illustrating a detection method for a reference angle marker according to the second embodiment;

FIG. 9 is an explanatory diagram illustrating a configuration of an optical distance measurement apparatus according to a third embodiment;

FIG. 10 is an explanatory diagram illustrating a method for detecting a first reference angle marker using signal strength distribution;

FIG. 11 is an explanatory diagram illustrating a method for detecting a second reference angle marker using signal strength distribution;

FIG. 12 is an explanatory diagram illustrating a configuration of an optical distance measurement apparatus according to a fourth embodiment;

FIG. 13 is an explanatory diagram illustrating a reference angle marker that is blocked by a mirror;

FIG. 14 is an explanatory diagram illustrating a configuration of an optical distance measurement apparatus according to fifth embodiment;

FIG. 15 is an explanatory diagram illustrating a method for detecting a reference rotation angle using signal strength of disturbance light;

FIG. 16 is an explanatory diagram illustrating a light reception area that is used for distance measurement and rotation angle deviation detection;

FIG. 17 is an explanatory diagram illustrating an image in which a reference angle marker is detected;

FIG. 18 is an explanatory diagram illustrating an example of a reference angle marker according to another embodiment; and

FIG. 19 is an explanatory diagram illustrating an example of a reference angle marker that is provided in a window portion.

### DESCRIPTION OF THE EMBODIMENTS

An optical distance measurement apparatus that includes a rotation angle sensor that detects a rotation angle of a mirror that reflects laser light for distance measurement, and a circuit that generates a clock signal for detecting a reference rotation angle of the mirror is known (for example, JP-A-2011-085577).

Regarding the optical distance measurement apparatus, there is a demand for the reference rotation angle of the mirror to be detected by a simple method, while increase in a number of components is suppressed.

It is thus desired to solve at least a portion of the above-described issues. The present disclosure can be implemented according to aspects or application examples below.

A first exemplary embodiment of the present disclosure provides an optical distance measurement apparatus. The optical distance measurement apparatus includes: a casing; a light emitting unit that emits laser light; a mirror that is arranged inside the casing and reflects the laser light that is emitted from the light emitting unit; a rotating unit that rotates the mirror; a light receiving unit that includes a light receiving element for receiving incident light; a window portion that is provided in the casing and is for emitting the laser light that is reflected by the mirror outside the casing; and a reference angle marker that is provided in the casing, and is detected by the light receiving unit based on a rotation angle of the mirror being a reference rotation angle that is prescribed in advance.

As a result of the optical distance measurement apparatus according to the first exemplary embodiment, the reference angle marker that is provided in the casing is detected by the light receiving unit when the rotation angle of the mirror is the reference rotation angle prescribed in advance. Therefore, a sensor or the like for detecting the reference rotation angle is not provided in the optical distance measurement apparatus, and increase in a number of components can be suppressed. The reference rotation angle can be detected by a simple method using the mirror and the light receiving unit.

A second exemplary embodiment of the present disclosure provides an optical distance measurement apparatus. The optical distance measurement apparatus includes: a casing; a light emitting unit that emits laser light; a mirror that is arranged inside the casing and reflects the laser light that is emitted from the light emitting unit; a rotating unit that rotates the mirror; a light receiving unit that includes a light receiving element for receiving incident light; a window portion that is provided in the casing and is for emitting the laser light that is reflected by the mirror outside the casing; and a reference angle marker that is detected by the light receiving unit based on a rotation angle of the mirror being a reference rotation angle that is prescribed in advance. The reference angle marker includes a boundary between the window portion and the casing.

As a result of the optical distance measurement apparatus according to the second exemplary embodiment, the reference angle marker that includes a boundary between the window portion and the casing is detected by the light receiving unit when the rotation angle of the mirror is the reference rotation angle prescribed in advance. Therefore, a sensor or the like for detecting the reference rotation angle is not provided in the optical distance measurement apparatus, and increase in a number of components can be suppressed. The reference rotation angle can be detected by a simple method using the mirror and the light receiving unit.

A third exemplary embodiment of the present disclosure provides an optical distance measurement apparatus. The optical distance measurement apparatus includes: a casing; a light emitting unit that emits laser light; a mirror that is arranged inside the casing and reflects the laser light that is emitted from the light emitting unit; a rotating unit that rotates the mirror; a light receiving unit that includes a light receiving element for receiving incident light; a window portion that is provided in the casing and is for emitting the laser light that is reflected by the mirror outside the casing; and a reference angle marker that is detected by the light receiving unit based on a rotation angle of the mirror being a reference rotation angle that is prescribed in advance. The reference angle marker includes an electrode or wiring of a heater that is provided in the window portion.

As a result of the optical distance measurement apparatus according to the third exemplary embodiment, the reference angle marker that includes an electrode or wiring of a heater that is provided in the window portion is detected by the light receiving unit when the rotation angle of the mirror is the reference rotation angle prescribed in advance. Therefore, a sensor or the like for detecting the reference rotation angle is not provided in the optical distance measurement apparatus, and increase in a number of components can be suppressed. The reference rotation angle can be detected by a simple method using the mirror and the light receiving unit.

### A. First Embodiment

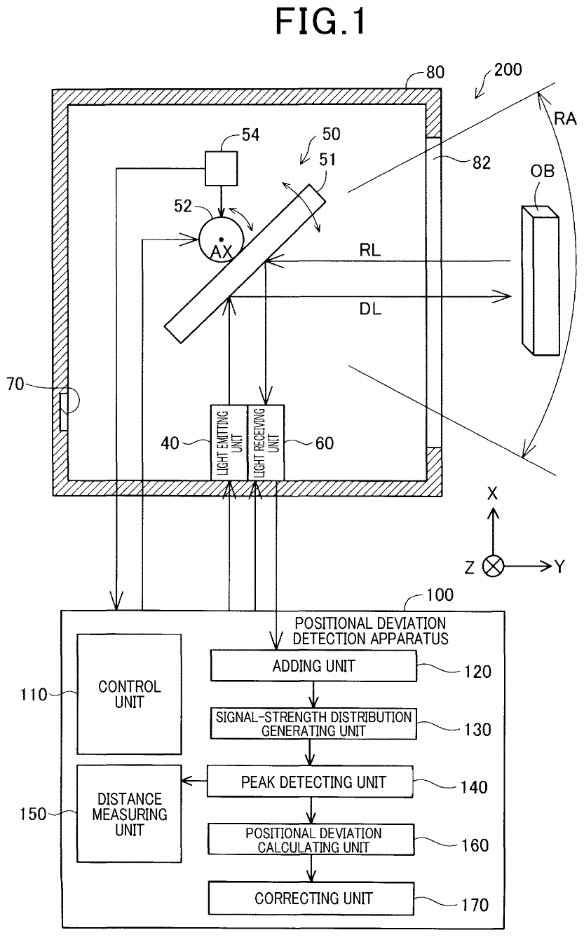

As shown in FIG. 1, an optical distance measurement apparatus 200 according to a first embodiment of the present disclosure includes a casing 80, a light emitting unit 40, a scanning unit 50, a light receiving unit 60, and a positional deviation detection apparatus 100. The light emitting unit 40, the scanning unit 50, and the light receiving unit 60 are arranged inside the casing 80. The casing 80 includes a window portion 82 and a reference angle marker 70. For example, the optical distance measurement apparatus 200 may be mounted in a vehicle, and may be used to detect an obstacle and measure a distance to the obstacle. Directions X, Y, and Z that are shown in the drawings are common among the drawings including FIG. 1.

The light emitting unit 40 includes a laser diode that is a semiconductor laser serving as a light source, and emits a laser light DL for distance measurement. According to the present embodiment, the laser light DL has an output width that is prescribed in advance in a vertical direction. To efficiently expand a scanning range, the output width of the laser light DL is preferably set in a direction that intersects a scanning direction of a rotating unit 52. For example, a size of the output width of the laser light DL can be arbitrarily set based on a number of light sources, an array of light sources, an angle of each of a plurality of light sources, use of a lens that is arranged inside the light emitting unit 40 and adjusts an output angle of the laser light DL, and the like. As the light source of the light emitting unit 40, in addition to the laser diode, another light source that is a solid-state laser may be used.

The scanning unit 50 is configured by a so-called one-dimensional scanner. The scanning unit 50 includes a mirror 51, the rotating unit 52, and a rotation angle sensor 54. The rotating unit 52 receives a control signal from a control unit 110, described hereafter, and performs forward rotation and reverse rotation with a center axis AX as a rotational axis, thereby scanning the mirror 51 that is fixed to the rotating unit 52 in one direction along a horizontal plane. The rotation angle sensor 54 is an incremental-type optical rotary encoder that detects A-phase and B-phase signals, and acquires a relative rotation angle. The rotation angle sensor 54 detects the rotation angle of the rotating unit 52 at every angle prescribed in advance. The rotation angle of the rotating unit 52 that is detected by the rotation angle sensor 54 is also referred to, hereafter, as a detection angle.

The window portion 82 is provided in a wall surface of the casing 80 on a Y-direction side in relation to the scanning unit 50. For example, the window portion 82 may be configured by a rectangular member such as glass that transmits the laser light DL. The laser light DL that is emitted from the light emitting unit 40 is reflected by the mirror 51, transmitted through the window portion 82, and emitted outside the casing 80.

A scanning range RA is a range over which the optical distance measurement apparatus 200 scans the laser light DL to perform distance measurement. Scanning within the scanning range RA is implemented by the control unit 110, described hereafter, rotating the rotating unit 52, while the rotation angle sensor 54 detects the rotation angle of the rotating unit 52. For example, when reflected light RL from a target such as an object OB that is within the scanning range RA is received, the light receiving unit 60 may output a signal that is based on a reception state of incident light to the positional deviation detection apparatus 100.

The positional deviation detection apparatus 100 includes a known microprocessor and memory. The positional deviation detection apparatus 100 controls each of the control unit 110, an adding unit 120, a signal-strength distribution generating unit 130, a peak detecting unit 140, a distance measuring unit 150, a positional deviation calculating unit 160, and a correcting unit 170 by the microprocessor running a program that is prepared in advance.

According to the present embodiment, the positional deviation detection apparatus 100 performs measurement of a distance to the object OB that is present within the scanning range RA, that is, distance measurement, and detection of a deviation amount of a rotation angle of the mirror 51 using the signal that is outputted by the light receiving unit 60. The positional deviation detection apparatus 100 may perform the detection of the deviation amount a plurality of times each time distance measurement is performed. Alternatively, the positional deviation detection apparatus 100 may perform the detection of the deviation amount at a specific timing, such as when the vehicle is stopped, when the vehicle is started, or when the optical distance measurement apparatus 200 is started.

The “deviation amount of the rotation angle of the mirror 51” refers to a deviation amount between the rotational angle of the mirror 51 and the detection angle of the rotating unit 52 that is detected by the rotation angle sensor 54. For example, deviation between the rotation angle and the detection angle may occur as a result of an absolute position of the rotation angle of the rotating unit 52 changing when the optical distance measurement apparatus 200 is started.

The control unit 110 controls each unit including the light emitting unit 40, the scanning unit 50, and the light receiving unit 60. More specifically, the control unit 110 outputs, in addition to a command signal for making the light emitting unit 40 emit light from the laser diode and an address signal for activating a light receiving element 68 of the light receiving unit 60, a command signal for making the signal-strength distribution generating unit 130 generate a histogram and a control signal for the rotating unit 52 of the scanning unit 50.

The adding unit 120 is a circuit that adds output of the light receiving element 68 that is included in a pixel 66 of the light receiving unit 60, described hereafter. When incident light enters a single pixel 66, each light receiving element 68 that is included in the pixel 66 outputs a signal. The adding unit 120 counts a number of signals that are substantially simultaneously outputted from a plurality of single-photon avalanche diodes (SPADs) that are included in each pixel 66 and thereby determines an added value for each pixel 66.

The signal-strength distribution generating unit 130 generates a histogram by adding together addition results of the adding unit 120 a plurality of times, and outputs the histogram to the peak detecting unit 140. The peak detecting unit 140 analyzes signal strength that is inputted from the signal-strength distribution generating unit 130 and detects a position of a peak of a signal that corresponds to the reflected light RL. The peak detecting unit 140 detects the position of the peak in relation to time for detection of distance, and detects the position of the peak in relation to the rotation angle of the rotating unit 52 for rotation angle deviation detection, described hereafter.

The distance measuring unit 150 performs measurement of the distance to the object OB that is present within the scanning range RA using so-called time-of-flight (TOF). More specifically, the distance measuring unit 150 calculates the distance to the object OB based on an amount of time from when the light emitting unit 40 emits the laser light DL to when the light receiving element 68 receives the reflected light RL. When the peak detecting unit 140 detects the peak of the signal that corresponds to the reflected light RL, the distance measuring unit 150 detects the distance to the object OB by detecting an amount of time from emission of irradiation light pulses to a peak in reflected light pulses.

The positional deviation calculating unit 160 performs rotation-angle deviation detection control, described hereafter, and detection of the deviation amount of the rotation angle of the mirror 51. The correcting unit 170 corrects the deviation amount of the rotation angle of the mirror 51 that is detected by the positional deviation calculating unit 160 in relation to the detection angle from the rotation angle sensor 54.

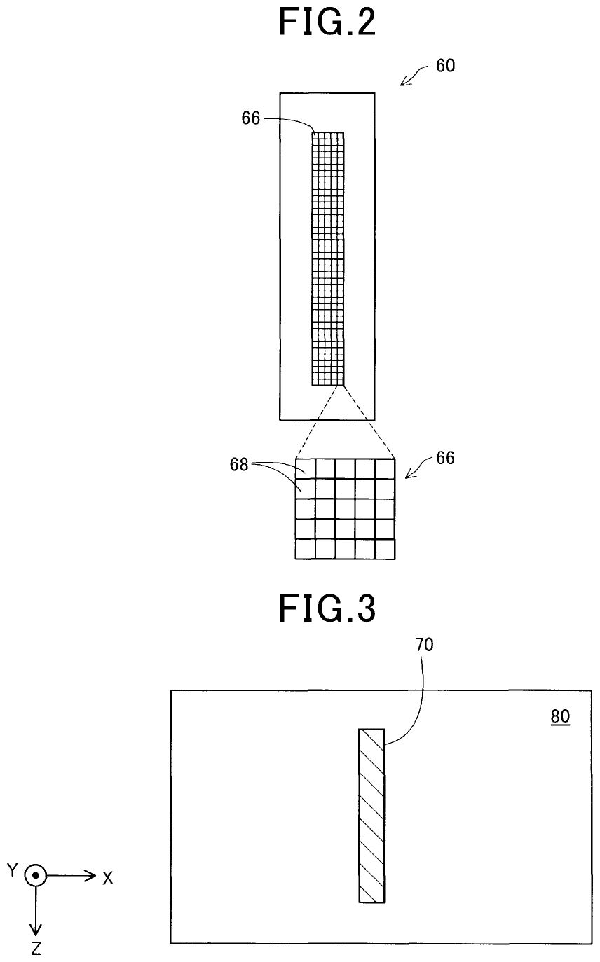

A configuration of the light receiving unit 60 will be described with reference to FIG. 2. The light receiving unit 60 includes a plurality of pixels 66 that are arrayed in a two-dimensional manner on a light receiving surface.

According to the present embodiment, the pixels 66 are arrayed in a substantially rectangular shape that is elongated along the vertical direction, so as to correspond to the output width of the laser light DL described above. The pixel 66 is configured by a plurality of light receiving elements 68 that output signals based on incident intensity of the reflected light from the object OB. According to the present embodiment, the pixel 66 is configured by the plurality of light receiving elements 68 that are arrayed five each in a horizontal direction and a vertical direction. However, the pixel 66 may be a single light receiving element 68. Alternatively, the pixel 66 may be configured by an arbitrary number of light receiving elements 68.

According to the present embodiment, the SPAD is used as the light receiving element 68. A p-i-n (PIN) photodiode may also be used as the light receiving element 68. When light (photon) enters, the SPAD outputs a pulse-like output signal that indicates incidence of light. The pulse signal that is outputted from the light receiving element 68 is inputted to the positional deviation detection apparatus 100.

A configuration of a reference angle marker 70 that is provided in the casing 80 will be described with reference to FIG. 3. The reference angle marker 70 is a detected body for detection of a reference rotation angle of the rotating unit 52 and can be detected by the light receiving unit 60. The reference rotation angle is a rotation angle of the mirror 51 that serves as reference for the detection of rotation angle deviation.

According to the present embodiment, as shown in FIG. 3, the reference angle marker 70 has a substantially rectangular shape of which a long direction is parallel to the Z direction. According to the present embodiment, the reference angle sensor 70 is formed by a material that has a higher reflectance than the wall surface of the casing 80. The reference angle marker 70 is fixed to the wall surface on an inner side of the casing 80 by attachment, assembly, or the like.

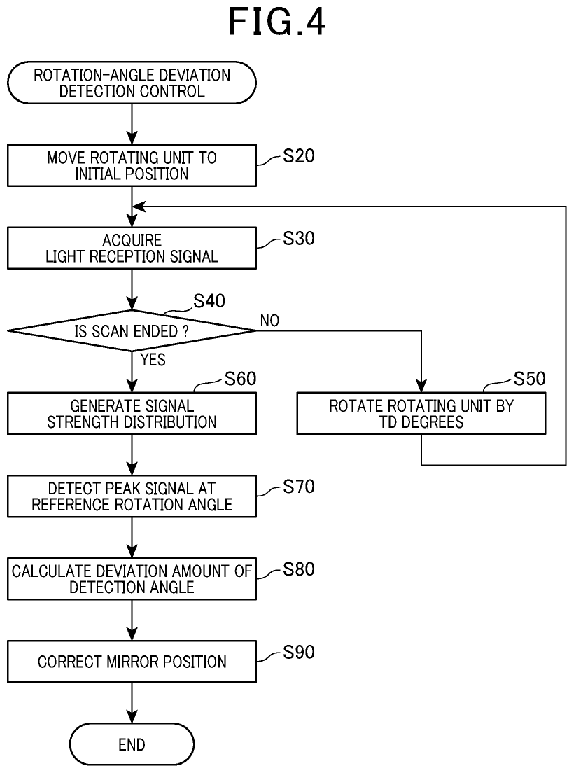

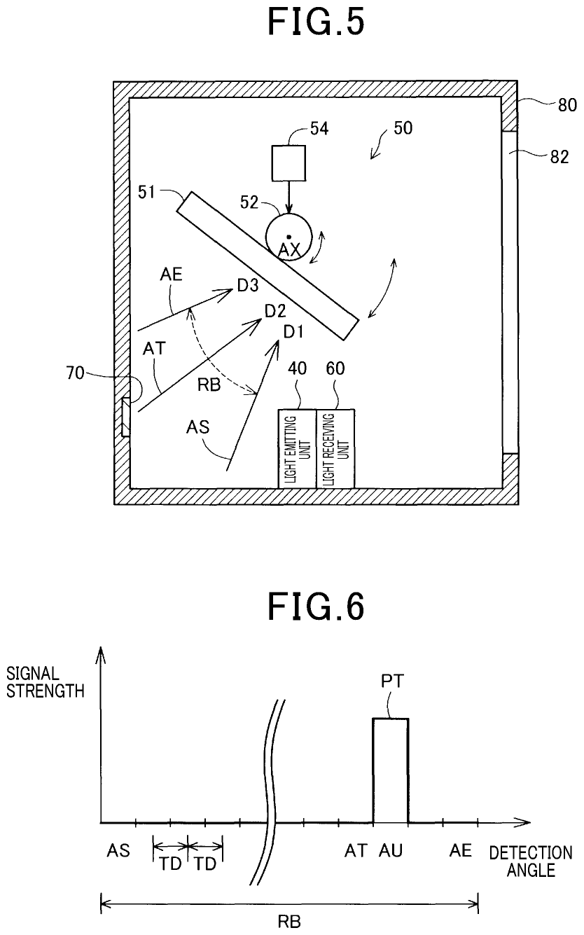

Rotation-angle deviation detection control using the reference angle marker 70 will be described with reference to FIG. 5 and FIG. 6 as appropriate, in addition to FIG. 4. For example, rotation-angle deviation detection control shown in FIG. 4 may be started by the optical distance measurement apparatus 200 being turned on and is performed before distance measurement by the optical distance measurement apparatus 200 is started. According to the present embodiment, rotation-angle deviation detection control is performed in a state in which the light emitting unit 40 is stopped. The control unit 110 rotates the rotating unit 52 and moves the mirror 51 to an initial position for rotation deviation detection (step S20).

Control of the rotating unit 52 in rotation-angle deviation detection control will be described with reference to FIG. 5. FIG. 5 shows the rotating unit 52 and the mirror 51 in a state in which the rotating unit 52 and the mirror 51 are moved to the initial position. The initial position of the rotating unit 52 can be arbitrarily set. For example, the initial position of the rotating unit 52 may be preferably set to a position in which incident light from the reference angle marker 70 can be easily detected, such as a position in which a reflection surface of the mirror 51 and the reference angle marker 70 oppose each other. The rotation angle of the rotating unit 52 in the initial position is a rotation angle AS. The mirror 51 in the initial position reflects incident light from direction D1 towards the light receiving unit 60.

Incident light from direction D2 includes the incident light from the reference angle marker 70. According to the present embodiment, the rotation angle of the rotating unit 52 at which the light receiving unit 60 is able to receive the incident light from direction D2 is a reference rotation angle AT. The rotation angle of the rotating unit 52 in a scanning end position is a rotation angle AE. The mirror 51 in the end position reflects incident light from direction D3 towards the light receiving unit 60. In rotation-angle deviation detection control, the control unit 110 scans a range RB of rotation angles from the initial position to the end position that are prescribed in advance and include the reference rotation angle AT, that is, from the rotation angle AS to the rotation angle AE, and makes the light receiving unit 60 receive the incident light.

The incident light from direction D1 is reflected by the mirror 51 in the initial position, acquired as light reception signals by the light receiving elements 68 of the light receiving unit 60, and inputted to the adding unit 120 of the positional deviation detection apparatus 100 as pulse signals (step S30). The adding unit 120 adds the output signals of the light receiving elements 68 that are included in the pixel 66. The control unit 110 detects whether the rotation angle of the rotating unit 52 has reached the rotation angle AE, that is, whether scanning of the range RB from the rotation angle AS to the rotation angle AE that are rotation angles that are prescribed in advance is completed (step S40).

When scanning of the rotation angles prescribed in advance is not completed (NO at step S40), the control unit 110 proceeds to step S50. The control unit 110 controls the rotating unit 52 and rotates the mirror 51 by a unit detection angle TD that is prescribed in advance (step S50). The unit detection angle TD that is prescribed in advance refers to a forwarding pitch of the rotation angle of the rotating unit 52 through control by the control unit 110. When the control unit 110 controls the rotating unit 52 and rotates the mirror 51 by the unit detection angle TD prescribed in advance, the control unit 110 proceeds to step S30.

When scanning of the range RB is completed, that is, when scanning at the rotation angle AE is completed (YES at step S40), the control unit 110 proceeds to step S60. The signal-strength distribution generating unit 130 adds the addition results of the adding unit 120 that are acquired over the range RB from the rotation angle AS to the rotation angle AE a plurality of times and generates a histogram. The signal-strength distribution generating unit 130 then outputs the histogram to the peak detecting unit 140 (step S60).

A detection method for rotation angle deviation by the positional deviation calculating unit 160 will be described with reference to FIG. 6. The positional deviation calculating unit 160 detects the deviation amount between the rotation angle of the mirror 51 and the detection angle of the rotation angle of the mirror 51 that is detected by the rotation angle sensor 54. FIG. 6 shows an example of a distribution of signal strength that is generated by the signal-strength distribution generating unit 130. A horizontal axis in FIG. 6 indicates detection angle and a vertical axis indicates magnitude of signal strength. The signal strength distribution in FIG. 6 is the distribution of signal strength within the range RB of rotation angles prescribed in advance, that is, from the rotation angle AS to the rotation angle AE.

As described above, the reference angle marker 70 is formed by a material that has a higher reflectance than the wall surface of the casing 80. Therefore, the incident light from the reference angle marker 70 is acquired as signal strength that is greater than the signal strength that is acquired from the wall surface of the casing 80 in the signal strength distribution of the range RB. In the example in FIG. 6, the peak detecting unit 140 detects a peak in signal strength at a detection angle AU as a peak signal PT (step S70).

The positional deviation calculating unit 160 calculates the deviation amount of the detection angle by calculating a difference between the detection angle AU of the peak signal PT that is detected by the peak detecting unit 140 and the reference rotation angle AT (step S80). In the example in FIG. 6, the detection angle AU is +TD degrees in relation to the reference rotation angle AT. The positional deviation calculating unit 160 detects the deviation amount of the rotation angle of the mirror 51 as +TD degrees.

The correcting unit 170 corrects the rotation angle of the rotating unit 52 by the deviation amount that is detected by the positional deviation calculating unit 160 (step S90). More specifically, the correcting unit 170 performs offset correction in which the rotating unit 52 is corrected by +TD degrees that is the deviation amount, on the detection angle from the rotation angle sensor 54. As a result of offset correction, the detection angle from the rotation angle sensor 54 and the rotation angle of the mirror 51 are in a matching state.

As described above, as a result of the optical distance measurement apparatus 200 according to the present embodiment, the reference angle marker 70 that is provided in the casing 80 is detected by the light receiving unit 60 when the rotation angle of the mirror 51 is the reference rotation angle AT prescribed in advance. That is, the reference rotation angle AT is detected using the reference angle marker 70. Therefore, a sensor or the like for detecting the reference rotation angle AT is not provided in the optical distance measurement apparatus 200, and increase in a number of components can be suppressed. The reference rotation angle AT can be detected by a simple method using the mirror 51 and the light receiving unit 60 that are constituent components of the optical distance measurement apparatus 200.

As a result of the optical distance measurement apparatus 200 according to the present embodiment, the positional deviation detection apparatus 100 generates the signal strength distribution of the light reception signals that are detected by the light receiving unit 60 for every unit detection angle TD, and acquires the detection angle AU of the reference rotation angle AT using the peak signal PT of signal strength that corresponds to the reference angle marker 70 in the signal strength distribution. The positional deviation detection apparatus 100 can detect the deviation amount between the rotation angle of the mirror 51 and the detection angle through comparison of the acquired detection angle AU and the reference rotation angle AT, and can correct the detection angle of the rotation angle sensor 54 to an appropriate value.

### B. Second Embodiment

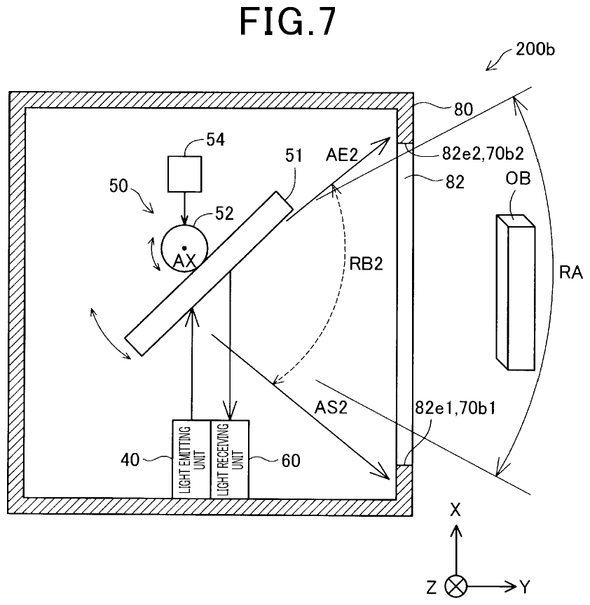

As shown in FIG. 7, an optical distance measurement apparatus 200b according to a second embodiment differs from the optical distance measurement apparatus 200 according to the first embodiment in that a reference angle marker 70b is provided instead of the reference angle marker 70. Other configurations are similar to those of the optical distance measurement apparatus 200 according to the first embodiment.

According to the present embodiment, boundaries 82e1 and 82e2 between the casing 80 that can reflect the laser light DL from the light emitting unit 40 and the window portion 82 that transmits the laser light DL function as the reference angle marker 70b. A reference rotation angle ATb1 is set for the boundary 82e1 between the casing 80 and an end portion on one side of the window portion 82. A reference rotation angle ATb2 is set for the boundary 82e2 between the casing 80 and an end portion on another side of the window portion 82. When the reference angle markers 70b are differentiated, the boundary 82e1 is a reference angle marker 70b1 on one side and the boundary 82e2 is a reference angle marker 70b2.

According to the present embodiment, rotation-angle deviation detection control by the positional deviation detection apparatus 100 is performed in a state in which the laser light DL is emitted from the light emitting unit 40, that is, in the distance measurement process. While making the light emitting unit 40 emit the laser light DL, the control unit 110 scans the rotating unit 52 while rotating the rotating unit 52 every unit detection angle TD, over a range RB2 from a rotation angle AS2 to a rotation angle AE2. The range RB2 is a range that is wider than the range RA for distance measurement and includes the boundaries 82e1 and 82e2.

According to the present embodiment, a distance image MP over the range RB2 is generated by the adding unit 120, the signal-strength distribution generating unit 130, the peak detecting unit 140, and the distance measuring unit 150 as a result of the light receiving unit 60 detecting the reflected light from the range RB2.

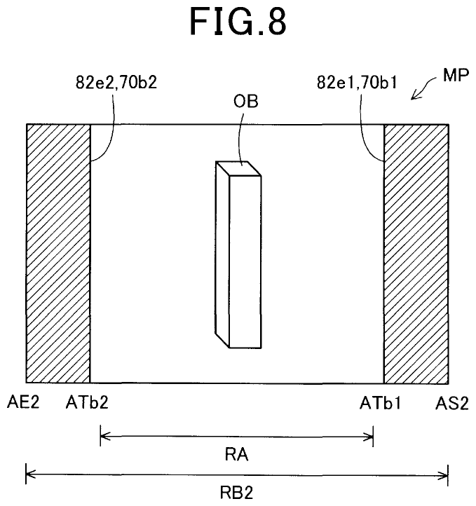

FIG. 8 shows an example of the distance image MP that is generated by the positional deviation detection apparatus 100. As shown in FIG. 8, the distance image MP shows, in addition to the object OB, the boundary 82e1 that is positioned at the reference rotation angle ATb1 and the boundary 82e2 that is positioned at the reference rotation angle ATb2. As described above, the window portion 82 has a rectangular shape, and the boundaries 82e1 and 82e2 are detected as straight lines that are parallel in the Z direction.

According to the present embodiment, the positional deviation calculating unit 160 calculates the deviation amount of the rotation angle of the mirror 51 by calculating a difference between a detection angle at which the boundary 82e1 is detected and the reference rotation angle ATb1. The positional deviation calculating unit 160 may calculate the deviation amount of the detection angle by calculating a difference between a detection angle at which the boundary 82e2 is detected and the reference rotation angle ATb2, in addition to or instead of the calculation of the difference between the detection angle and the reference rotation angle ATb1. The positional deviation calculating unit 160 may calculate the deviation amount of the detection angle for each pixel in the Z direction at the boundaries 82e1 and 82e2 that are detected as a plurality of pixels that are in straight lines that are parallel in the Z direction in the distance image MP.

As a result of a plurality of pixels being used for detection of the deviation amount, detection accuracy regarding the deviation amount can be increased. The positional deviation detection apparatus 100 may calculate the deviation amount of the detection angle using mapping results of signal strength or luminance of the reflected light from the boundaries 82e1 and 82e2 that are acquired by the light receiving unit 60, without using the distance image MP.

As described above, as a result of the optical distance measurement apparatus 200b according to the present embodiment, the deviation amounts between the detection angles and the reference rotation angles ATb1 and ATb2 are detected using the boundaries 82e1 and 82e2 between the casing 80 and the window portion 82 that are constituent components for distance measurement of the optical distance measurement apparatus 200b.

Therefore, the reference rotation angles ATb1 and ATb2 can be detected by a simple method and deviation of the detection angles can be corrected, while a sensor or the like for detecting the reference rotation angles ATb1 and ATb2 is not provided in the optical distance measurement apparatus 20 and increase in the number of components is suppressed. Because the positional deviation detection apparatus 100 uses the distance image MP from distance measurement, the deviation amount of the detection angle can be detected in addition to distance measurement by the optical distance measurement apparatus 200.

### C. Third Embodiment

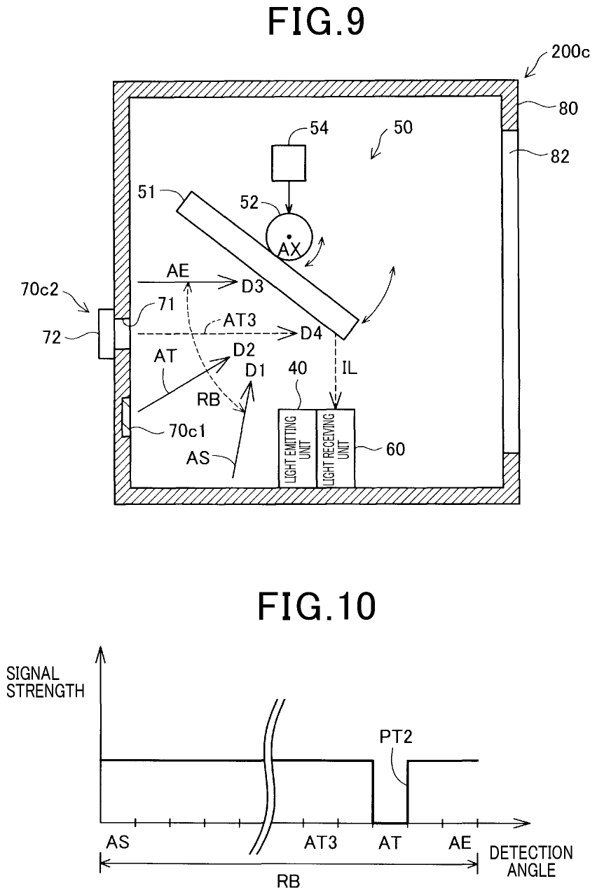

As shown in FIG. 9, an optical distance measurement apparatus 200c according to a third embodiment differs from the optical distance measurement apparatus 200 according to the first embodiment in that a first reference angle marker 70c1 and a second reference angle marker 70c2 are provided instead of the reference angle marker 70. Other configurations are similar to those of the optical distance measurement apparatus 200 according to the first embodiment. The optical distance measurement apparatus 200c performs rotation-angle deviation detection control by switching the marker that is used based on luminance inside the casing 80, as described hereafter.

The first reference angle marker 70c1 differs from the reference angle marker 70 according to the first embodiment in that the first reference angle marker 70c1 has a lower reflectance than the wall surface of the casing 80. For example, the first reference angle marker 70c1 may be formed by a material that has a lower reflectance than the wall surface of the casing 80, or by being processed to have a surface roughness that is greater than a surface roughness of the wall surface of the casing 80.

When the first reference angle marker 70c1 is provided in the window portion 82, the first reference angle marker 70c1 may be configured to have a lower reflectance than the window portion 82. The first reference angle marker 70c1 may be configured to have a higher reflectance than the wall surface of the casing 80 or the window portion 82.

The second reference angle marker 70c2 is arranged in a position that correspond to a reference rotation angle AT3 that is included in the range RB from the rotation angle AS to the rotation angle AE. The reference rotation angle AT3 is a rotation angle of the rotating unit 52 at which the light receiving unit 60 is able to receive incident light from direction D4 that includes incident light from the second reference angle marker 70c2.

The second reference angle marker 70c2 is configured by an opening portion 71 that is provided in the casing 80 and a light source unit 72 that is attached to a wall surface on an outer side of the casing 80. The opening portion 71 is a through-hole that is provided in the wall surface of the casing 80 and is a through-hole that has a substantially rectangular shape of which the long direction is parallel to the Z direction. For example, the light source unit 72 may be a light emitting element such as a light emitting diode and emits irradiation light IL through the opening portion 71 in direction D4 inside the casing 80.

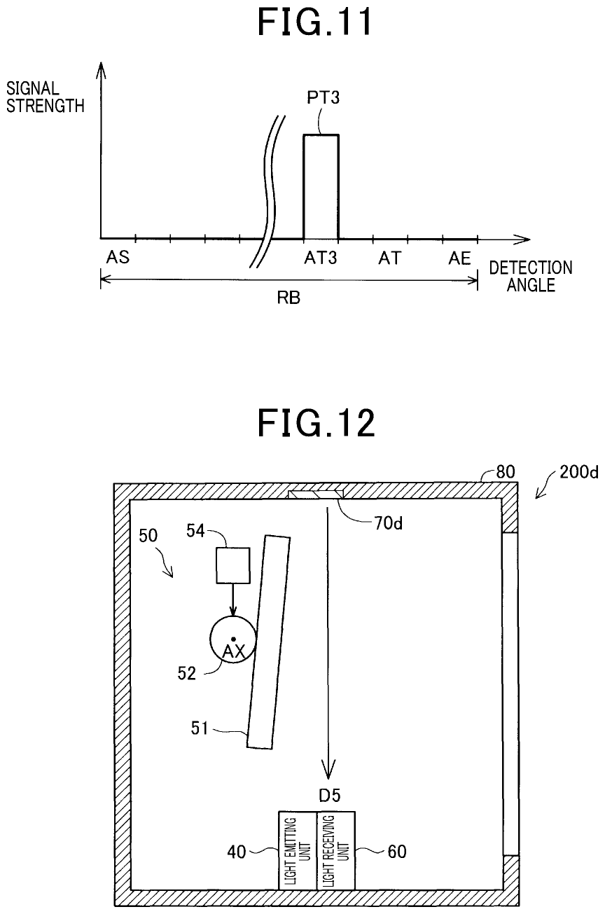

A detection method for the reference rotation angle AT using the first reference angle marker 70c1 and a detection method for the reference rotation angle AT using the second reference angle marker 70c2 by the positional deviation calculating unit 160 will be described with reference to FIG. 10 and FIG. 11. When rotation-angle deviation detection control is started, the optical distance measurement apparatus 200c according to the present embodiment receives incident light by the light receiving unit 60 in a state in which the light emitting unit 40 is stopped, and determines whether an interior of the casing 80 is in a dark state or a light state.

More specifically, the positional deviation detection apparatus 100 determines that the interior of the casing 80 is in the dark state when a magnitude of the signal strength of the incident light acquired by the light receiving unit 60 is less than a threshold that is prescribed in advance and determines that the interior of the casing 80 is in the light state when the magnitude of the signal strength is equal to or greater than the threshold that is prescribed in advance.

When the light reception signal that is detected by the light receiving unit 60 is equal to or greater than the signal strength that is prescribed in advance, that is, when the interior of the casing 80 is determined to be in the light state, the positional deviation detection apparatus 100 performs rotation-angle deviation detection control using the first reference angle marker 70c1.

FIG. 10 shows an example of the signal strength distribution in the light state that is acquired by scanning of the range RB. The first reference angle marker 70c1 has a lower reflectance than the wall surface of the casing 80. Therefore, the positional deviation detection apparatus 100 can detect the reference rotation angle AT by detecting a peak signal PT2 of low signal strength.

When the light reception signal that is detected by the light receiving unit 60 is determined to be less than the signal strength prescribed in advance, that is, when the interior of the casing 80 is determined to be in the dark state, the positional deviation detection apparatus 100 performs rotation-angle deviation detection control using the second reference angle marker 70c2. In rotation-angle deviation detection control in the dark state, the control unit 110 turns on the light source unit 72.

As shown in FIG. 9, the irradiation light IL that is emitted from the light source unit 72 can be emitted in direction D4, reflected by the mirror 51 at the reference rotation angle AT3, and received by the light receiving unit 60.

FIG. 11 shows an example of the signal strength distribution in the dark state that is acquired by scanning of the range RB. The positional deviation detection apparatus 100 can detect the reference rotation angle AT by detecting a peak signal PT3 by the irradiation light IL that is emitted from the second reference angle marker 70c2.

As described above, as a result of the optical distance measurement apparatus 200c according to the present embodiment, the first reference angle marker 70c1 that has a lower reflectance than the wall surface of the casing 80 and the second reference angle marker 70c2 that emits the irradiation light IL from the light source unit 72 are included. Through use of the first reference angle marker 70c1, the reference rotation angle AT can be detected even when the interior of the casing 80 is in the light state. Through use of the second reference angle marker 70c2, the reference rotation angle AT can be detected even when the interior of the casing 80 is in the dark state.

As a result of the optical distance measurement apparatus 200c according to the present embodiment, whether the interior of the casing 80 is in the light state or the dark state is determined through a comparison of the light reception signal that is detected by the light receiving unit 60 and the signal strength that is prescribed in advance, and rotation-angle deviation detection control is performed by the marker to be used being switched based on the light/dark state inside the casing 80. Consequently, regardless of brightness of an environment in which the optical distance measurement apparatus 200c is arranged, the reference rotation angle can be detected and the rotation angle deviation can be detected.

### D. Fourth Embodiment

As shown in FIG. 12, an optical distance measurement apparatus 200d according to a fourth embodiment differs from the optical distance measurement apparatus 200 according to the first embodiment in that a reference angle marker 70d is provided instead of the reference angle marker 70. Other configurations are similar to those of the optical distance measurement apparatus 200 according to the first embodiment. The reference angle marker 70d is formed by a material that has a higher reflectance than the wall surface of the casing 80 and is fixed to the wall surface of the casing 80 in a position that opposes the light emitting unit 40 and the light receiving unit 60.

FIG. 12 shows the mirror 51 in a state in which the rotation angle is in an initial position. As shown in FIG. 12, in the state in which the mirror 51 is arranged with the rotation angle in the initial position, the light receiving unit 60 can receive incident light from the reference angle marker 70d that is indicated by direction D5. The mirror 51 that is in the initial position does not reflect the emitted light from the light emitting unit 40. That is, according to the present embodiment, the rotation angle of the mirror 51 in the initial position is the reference rotation angle.

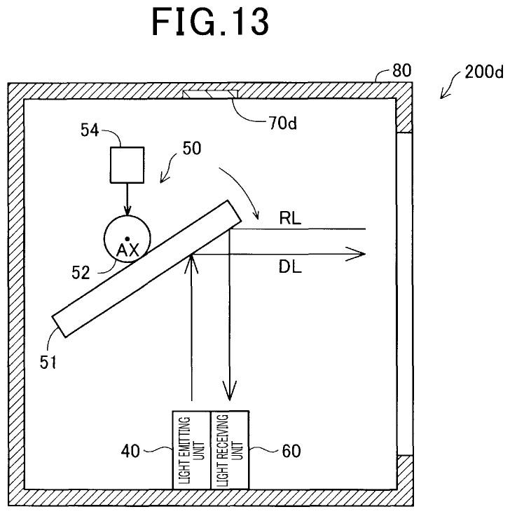

When the rotating unit 52 in the initial position is rotated, as shown in FIG. 13, the mirror 51 is in a state in which the mirror 51 can reflect the laser light DL that is emitted from the light emitting unit 40. Meanwhile, when the mirror 51 is rotated by the rotating unit 52, as shown in FIG. 13, the reference angle marker 70d is blocked by the mirror 51 and the light receiving unit 60 no longer receives the incident light from the reference angle marker 70d. That is, in the optical distance measurement apparatus 200d according to the present embodiment, the rotation angle of the rotating unit 52 in the initial position is the reference rotation angle. The deviation amount of the rotation angle of the mirror 51 is detected by a comparison of the rotation angle of the rotating unit 52 in the initial position and the detection angle from the rotation angle sensor 54.

As a result of the optical distance measurement apparatus 200d according to the present embodiment, the reference angle marker 70d is arranged in a position that can be detected by the light receiving unit 60 in a state in which the mirror 51 is arranged at the rotation angle of the initial position. As a result of the position at which the reference rotation angle can be detected being set to a position that is near the start position for distance measurement by the optical distance measurement apparatus 200d, a range over which the rotating unit 52 is rotated during distance measurement and detection of the reference rotation angle can be reduced.

When the mirror 51 is rotated by the rotating unit 52, the reference angle marker 70d is blocked by the mirror 51. Therefore, an issue in which incident light from the reference angle marker 70d is received as disturbance light during distance measurement by the optical distance measurement apparatus 200d can be suppressed.

### F. Fifth Embodiment

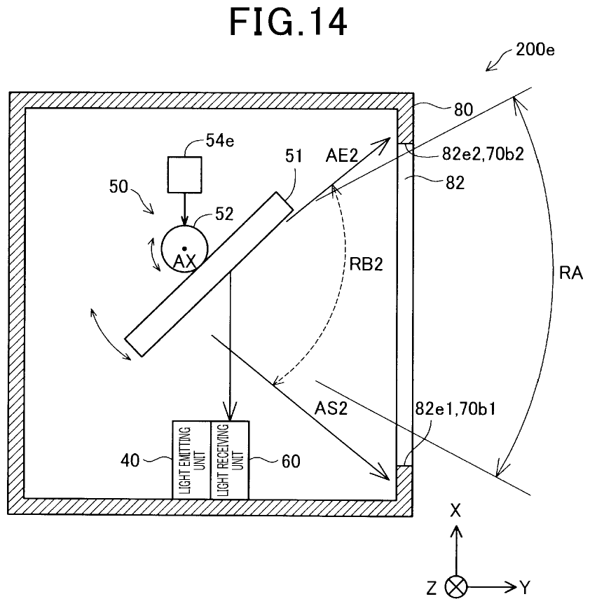

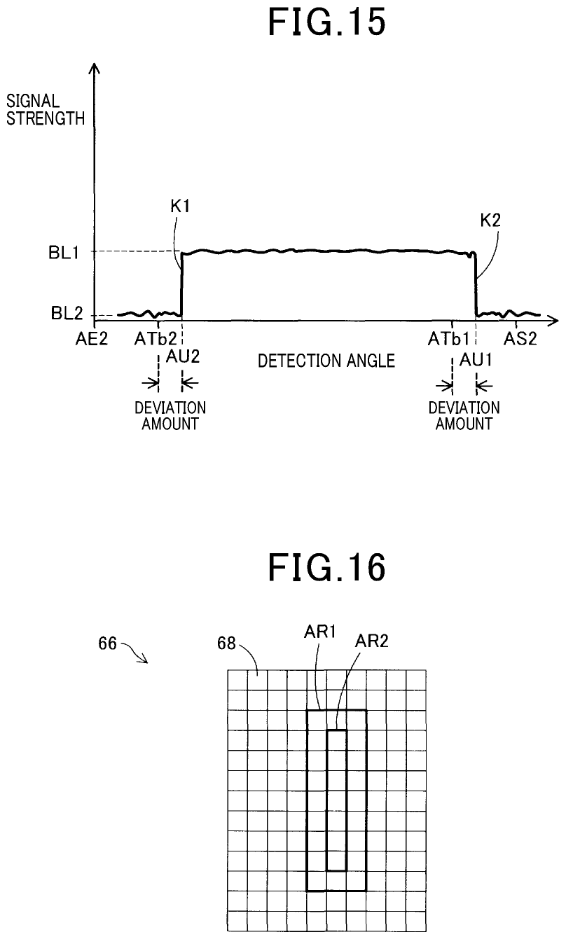

A configuration of an optical distance measurement apparatus 200e according to a fifth embodiment will be described with reference to FIG. 14 and FIG. 15. As shown in FIG. 14, the optical distance measurement apparatus 200e according to the fifth embodiment differs from the optical distance measurement apparatus 200b according to the second embodiment in that a rotation angle sensor 54e is provided instead of a rotation angle sensor 54. Other configurations are similar to those of the optical distance measurement apparatus 200b according to the second embodiment.

According to the present embodiment, in a manner similar to that according to the second embodiment, the boundaries 82e1 and 82e2 between the casing 80 and the window portion 82 function as the reference angle markers 70b1 and 70b2. According to the present embodiment, in rotation-angle deviation detection control by the positional deviation detection apparatus 100, control is performed by so-called disturbance light being acquired by the light receiving elements 68 of the light receiving unit 60 as the light reception signal.

The rotation angle senor 54e is an incremental-type optical rotary encoder that acquires an absolute rotation angle and a relative rotation angle in relation to the absolute rotation angle through detection of A-phase, B-phase, and Z-phase signals. An absolute-type encoder that is capable of acquiring an absolute rotation angle may be used as the rotation angle sensor 54e.

FIG. 15 schematically shows an example of the signal strength distribution that is generated by the signal-strength distribution generating unit 130 when scanning of the range RB2 is completed. The results shown in FIG. 15 correspond to the results of a single pixel 66 in the Z direction. FIG. 15 shows signal strength BL1 of disturbance light that is incident from the window portion 82, and signal strength BL2 of disturbance light from the rotation angle AS2 to the detection angle of the boundary 82e1 and from the rotation angle AE2 to the detection angle of the boundary 82e2, that is, disturbance light inside the casing 80.

In general, the signal strength BL1 is greater than the signal strength BL2, and a detection angle at a point of change K1 from the signal strength BL2 to the signal strength BL1 and a detection angle at a point of change K2 from the signal strength BL1 to the signal strength BL2 can be considered to be the detection angles of the boundaries 82e1 and 82e2.

The control unit 110 stops the light emitting unit 40, rotates the rotating unit 52 in a state in which the light receiving unit 60 is being driven, and scans the range RB2 from the rotation angle AS2 to the rotation angle AE3 that includes the reference rotation angles ATb1 and ATb2 described above with reference to FIG. 8.

The peak detecting unit 140 analyzes a histogram shown in FIG. 15 that is inputted from the signal-strength distribution generating unit 130 and, for example, may calculate a change amount of the signal strength in relation to the detection angle by differential or the like. The peak detecting unit 140 thereby extracts a peak in the change amount that corresponds to the point of change K1. The peak detecting unit 140 detects a detection angle AU1 from the peak that corresponds to the point of change K1 and outputs the detection angle AU1 to the positional deviation calculating unit 160.

The positional deviation calculating unit 160 calculates the deviation amount of the rotation angle of the mirror 51 by calculating a difference between the detection angle AU1 of the boundary 82e1 and the reference rotation angle ATb1 set for the boundary 82e1. The positional deviation calculating unit 160 may calculate the deviation amount of the detection angle by performing calculation of a difference between a detection angle AU2 of the boundary 82e2 that is derived from the point of change K2 and the reference rotation angle ATb2, in addition to or instead of the calculation of the difference between the detection angle AU1 and the reference rotation angle ATb1.

As a result of the optical distance measurement apparatus 200e according to the present embodiment, the detection angle AU1 of the boundary 82e1 of the window portion 82 is detected using disturbance light. Therefore, the deviation amount of the rotation angle can be detected by a simple configuration without the light emitting unit 40 being driven. In addition, the deviation amount of the rotation angle can be detected during a stopped period the light emitting unit 40, that is, a stopped period of the distance measurement process.

As a result of the optical distance measurement apparatus 200e according to the present embodiment, the incremental-type encoder that acquires the absolute rotation angle and the relative rotation angle of the mirror 51 is used as the rotation angle sensor 54. For example, as a result of the relative rotation angle of the mirror 51 being detected when the optical distance measurement apparatus 200e is started or the like, the mirror 51 can be returned to a point of origin at the relative rotation angle based on the absolute rotation angle. Therefore, deviation of the rotation angle of the mirror 51 during the stopping period of the optical distance measurement apparatus 200 can be suppressed or prevented.

### F. Other Embodiments

(F1) According to the above-described embodiments, an example in which a range of the light emitting elements 68 that are used in distance measurement and rotation angle deviation detection over the scanning range RA is the same is given.

In contrast, as shown in FIG. 16, the range of the light emitting elements 68 that are used may be switched for distance measurement and rotation angle deviation detection over the scanning range RA. In the example in FIG. 16, the control unit 110 outputs an address signal to activate a light reception area AR1 that is composed of 3×9 number of light receiving elements 68, for example, for distance measurement, and outputs an address signal to activate a light reception area AR2 that is composed of 1×7 number of light receiving elements 68, for example, for rotation angle deviation detection.

As a result of the optical distance measurement apparatus according to this embodiment, as a result of the light reception area AR2 that is activated for rotation angle deviation detection being smaller than the light reception area AR1 for distance measurement, measurement error can be reduced and the rotation angle deviation can be detected with higher resolution.

(F2) According to the above-described embodiments, an example in which the reference rotation angle is detected by the reference angle marker is given. In contrast, the positional deviation detection apparatus 100 may detect presence or absence of an abnormality in the optical distance measurement apparatus 200 using changes in a shape of a geometric figure that is detected by the light receiving unit 60.

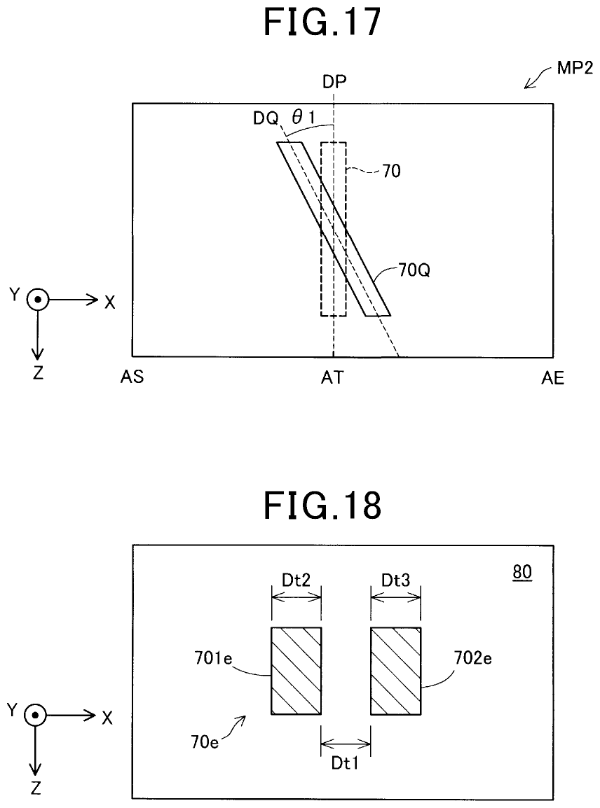

FIG. 17 shows an image MP2 that shows a signal strength distribution that is acquired by each light receiving element 68 on a two-dimensional plate. A direction along a long direction of the reference angle marker 70 in a state in which the reference angle marker 70 is appropriately detected is direction DP.

When a detection image of the reference angle marker 70 that is detected by the light receiving unit 60 is a detection marker 70Q and a direction along a long direction of the detection marker 70Q is direction DQ, using an angle θ1 between direction DP and direction DQ, an abnormality other than the reference rotation angle, such as installation abnormality of sections such as the light emitting unit or an optical system such as a lens of the optical distance measurement apparatus 200 may be detected. An abnormality in the optical system of the optical distance measurement apparatus 200 may be detected based on a distortion of the shape of the detection marker 70Q. Blurring of the detection marker 70Q may be detected and an abnormality such as focus shift in the optical system may be detected.

(F3) According to the above-described first embodiment, an example in which the reference angle marker 70 has a substantially rectangular shape is described. In contrast, the shape of the reference angle marker 70 may be various geometric shapes such as a square, a circle, or a straight line, in addition to a rectangle.

FIG. 18 shows a reference angle marker 70e that serves as an example of the reference angle marker 70. The reference angle marker 70e includes a marker 701e that has a substantially rectangular shape in which the long direction is parallel to the Z direction and a short direction has a distance Dt2, and a marker 702e in which the long direction is parallel to the Z direction and the short direction has a distance Dt3. The marker 701e and the marker 702e are arranged on the wall surface of the casing 80 so as to be separated from each other by a distance Dt1.

As a result of the optical distance measurement apparatus according to this embodiment, a number of detections can be increased by the plurality of reference angle markers 70e that are composed of the marker 701e and the marker 702e. Abnormalities in the sections of the optical distance measurement apparatus, such as an installation abnormality of the light receiving unit 60, an abnormality in a light receiving lens, and an installation abnormality of the mirror 51, can be detected based on shifting in the distances Dt1, Dt2, and Dt3 in the detection image of the marker 701e and the marker 702e that is acquired by the light receiving unit 60, changes in parallelism and shape between the marker 701e and the marker 702e, focus shift, and the like.

(F4) According to the above-described embodiments, the scanning unit 50 is described giving a one-dimensional scanner that includes the rotating unit 52 and the mirror 51 as an example. However, the scanning unit 50 may be configured by a two-dimensional scanner that is configured by a rotating unit that rotates in axial directions that are orthogonal to each other and a mirror. In addition, according to the above-described embodiments, an example in which the rotating unit 52 scans the mirror 51 in one direction along the horizontal plane, that is, the horizontal direction is given. However, for example, the mirror 51 may be scanned along the vertical direction or may be scanned along one arbitrary direction. In this case, the array of the pixels 66 in the light receiving unit 60 may be arrayed in a substantially rectangular shape that is elongated along the horizontal direction so as to correspond to the output width of the laser light DL.

(F5) According to the above-described embodiments, an example in which the control unit 110 controls the rotating unit 52 and scans the range RB by rotating the mirror 51 by the unit detection angle TD prescribed in advance is given. In contrast, during an initial scan of the range RB, the range RB may be scanned at a detection angle that is greater than the unit detection angle TD, such as a detection angle of 2×TD or 3×TD. After an approximate position of the reference angle marker 70 is identified, an area near the identified reference angle marker 70 may be scanned at a higher resolution, at the unit detection angle TD. According to such an embodiment, a total detection period of the reference angle marker 70 can be shortened.

(F6) According to the above-described second embodiment, an example in which the reference rotation angles ATb1 and ATb2 are detected from the reference angle markers 70b1 and 70b2 using the boundaries 82e1 and 82e2 between the casing 80 and the window portion 82 as the reference angle markers 70b1 and 70b2 is given. In contrast, for example, the boundaries 82e1 and 82e2 may be formed in straight lines along the Z direction. Abnormalities in the sections of the optical distance measurement apparatus, such as an installation abnormality of the light receiving unit 60, an abnormality in a light receiving lens, and an installation abnormality of the mirror 51, may be detected based on the detection image of the boundaries 82e1 and 82e2 by the light receiving unit 60.

(F7) According to the above-described third embodiment, an example in which the first reference angle marker 70c1 and the second reference angle marker 70c2 are used so as to be switched for the dark state and the light state is given. In contrast, in rotation angle deviation detection, the optical distance measurement apparatus may not perform light reception of incident light by the light receiving unit 60. That is, the light/dark state may not be acquired. The optical distance measurement apparatus may acquire the reference rotation angle from either of the first reference angle marker 70c1 and the second reference angle marker 70c2 that can be detected by the light receiving unit 60.

(F8) According to the above-described third embodiment, an example in which the first reference angle marker 70c1 and the second reference angle marker 70c2 are both provided is described. However, an embodiment in which only either is provided is also possible. Of the first reference angle marker 70c1 and the second reference angle marker 70c2, the reference angle marker that is suitable depending on the light/dark state inside the casing 80 is preferably provided.

(F9) According to the above-described embodiment, examples of the reference angle marker that is provided inside the casing 80 and an example in which the boundaries 82e1 and 82e2 between the casing 80 and the window portion 82 are used as the reference angle marker are given. In contrast, the reference angle marker may be provided in the window portion 82. In addition, a member that is provided in the window portion 82 may be used as the reference angle marker.

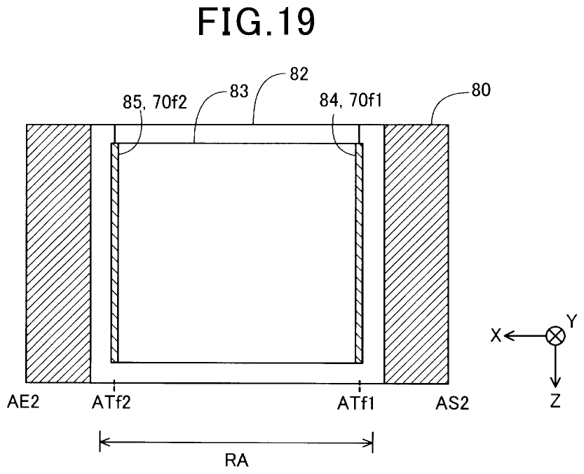

FIG. 19 shows an example of reference angle markers 70f1 and 70f2 that are provided in the window portion 82. According to the present embodiment, a heater 83 is provided in the window portion 82. For example, the heater 83 may be used to prevent condensation in the window portion 82 and the like. The heater 83 includes a transparent film that has conductivity, and electrodes 84 and 85 that are provided near both ends of the window portion 82. The heater 83 generates heat by being energized by a voltage being applied to the electrodes 84 and 85. The electrodes 84 and 85 have a shape that is elongated along the Z direction and are arranged in positions that are at reference rotation angles ATf1 and ATf2.

According to the present embodiment, the electrodes 84 and 85 function as the reference angle markers 70f1 and 70f2. For example, the positional deviation detection apparatus 100 may acquire detection angles of the electrodes 84 and 85 using the light reception signals that are outputted from the light receiving unit 60 that receive reflected light from the electrodes 84 and 85 of the laser light DL in distance measurement. The positional deviation detection apparatus 100 thereby detects the deviation amount of the rotation angle from a difference with the reference rotation angles ATf1 and ATf2. The deviation amount of the rotation angle may also be detected from a distance image or distance data of the electrodes 84 and 85 that is generated using the light reception signals. The electrodes 84 and 85 may be arranged so as to be parallel to each other.

Abnormalities in the sections of the optical distance measurement apparatus, such as an installation abnormality of the light receiving unit 60, an abnormality in a light receiving lens, and an installation abnormality of the mirror 51, may be detected based on an arrangement relationship of the reference angle markers 70f1 and 70f2. The reference angle markers 70f1 and 70f2 may be wiring for energizing the electrodes 84 and 85, instead of the electrodes 84 and 85. As the reference angle markers 70f1 and 70f2, a geometric pattern that can be detected by the light receiving unit 60 may be drawn in the window portion 82, instead of the electrodes 84 and 85. The deviation amount of the rotation angle may be detected from a difference between a reference rotation angle that is set for the geometric pattern and a detection angle.

As a result of the optical distance measurement apparatus 200 according to this embodiment, the scanning range in rotation-angle deviation detection control can be kept within the window portion 82. Compared to a case in which the interior of the casing 80 is included in the scanning range, detection speed regarding the deviation amount of the rotation angle can be improved.

The control unit and the method thereof described in the present disclosure may be implemented by a dedicated computer that is provided so as to be configured by a processor and a memory, the processor being programmed to provide one or a plurality of functions that are realized by a computer program.

Alternatively, the control unit and the method thereof described in the present disclosure may be implemented by a dedicated computer that is provided by a processor being configured by a single dedicated hardware logic circuit or more. Still alternatively, the control unit and the method thereof described in the present disclosure may be implemented by a single dedicated computer or more, the dedicated computer being configured by a combination of a processor that is programmed to provide one or a plurality of functions, a memory, and a processor that is configured by a single hardware logic circuit or more. In addition, the computer program may be stored in a non-transitory computer-readable storage medium that can be read by a computer as instructions performed by the computer.

The present disclosure is not limited to the above-described embodiments and can be implemented through various configurations without departing from the spirit of the disclosure. For example, technical features according to embodiments that correspond to technical features in each aspect described in the summary of the invention can be replaced and combined as appropriate to solve some or all of the above-described issued or to achieve some or all of the above-described effects. Furthermore, the technical features may be omitted as appropriate unless described as a requisite in the present specification.

What is claimed is:

1. An optical distance measurement apparatus comprising:
a casing;
a light emitting unit that emits laser light;
a mirror that is arranged inside the casing and reflects the laser light that is emitted from the light emitting unit;
a rotating unit that rotates the mirror;
a light receiving unit that includes a light receiving element for receiving incident light;
a window portion that is provided in the casing and is for emitting the laser light that is reflected by the mirror outside the casing; and
a reference angle marker that is provided in the casing, and is detected by the light receiving unit based on a rotation angle of the mirror being a reference rotation angle that is prescribed in advance.

2. An optical distance measurement apparatus comprising:
a casing;
a light emitting unit that emits laser light;
a mirror that is arranged inside the casing and reflects the laser light that is emitted from the light emitting unit;
a rotating unit that rotates the mirror;
a light receiving unit that includes a light receiving element for receiving incident light;
a window portion that is provided in the casing and is for emitting the laser light that is reflected by the mirror outside the casing; and
a reference angle marker that is detected by the light receiving unit based on a rotation angle of the mirror being a reference rotation angle that is prescribed in advance, wherein:
the reference angle marker includes a boundary between the window portion and the casing.

3. An optical distance measurement apparatus comprising:
a casing;
a light emitting unit that emits laser light;
a mirror that is arranged inside the casing and reflects the laser light that is emitted from the light emitting unit;
a rotating unit that rotates the mirror;
a light receiving unit that includes a light receiving element for receiving incident light;
a window portion that is provided in the casing and is for emitting the laser light that is reflected by the mirror outside the casing; and
a reference angle marker that is detected by the light receiving unit based on a rotation angle of the mirror being a reference rotation angle that is prescribed in advance, wherein:
the reference angle marker includes an electrode or wiring of a heater that is provided in the window portion.

4. The optical distance measurement apparatus according to claim 1, wherein:
the rotating unit scans the mirror along one direction;
the light emitting unit emits the laser light that has a width that is prescribed in advance in a direction that intersects the one direction; and
the light receiving unit includes a plurality of light receiving elements, and the plurality of light receiving elements are arranged so as to correspond to the width that is prescribed in advance.

5. The optical distance measurement apparatus according to claim 1, further comprising:
a rotation angle sensor that detects the rotation angle of the mirror; and
a positional deviation detection apparatus that detects a deviation amount between the rotation angle of the mirror and a detection angle of the rotation angle of the mirror that is detected by the rotation angle sensor,
the positional deviation detection apparatus is configured to
control the rotating unit and rotate the mirror by a unit detection angle that is prescribed in advance within an angular range that includes the reference rotation angle,
acquire a light reception signal at every unit detection angle prescribed in advance that is detected by the light receiving unit, and generate at least either of a distribution of the light reception signals or a distribution of distances that are acquired using the light reception signals,
acquire a detection angle of the reference rotation angle using the light reception signal or the distance that corresponds to the reference angle marker in the at least either of the distributions that is generated, and
detect the deviation amount by comparing the acquired detection angle of the reference rotation angle and the reference rotation angle prescribed in advance.

6. The optical distance measurement apparatus according to claim 5, wherein:
the rotation angle sensor is an encoder that acquires an absolute rotation angle of the mirror and a relative rotation angle in relation to the absolute rotation angle.

7. The optical distance measurement apparatus according to claim 5, wherein:
the reference angle marker includes at least either of
a first reference angle marker that has a reflectance that differs from a reflectance of a material that composes the casing or the window portion, and
a second reference angle marker that is configured by an opening portion that is provided in the casing and a light source unit that emits irradiation light into the casing through the opening portion.

8. The optical distance measurement apparatus according to claim 7, wherein:
the reference angle marker includes both the first reference angle marker and the second reference angle marker; and
the positional deviation detection apparatus is configured to
detect the detection angle of the reference rotation angle using the first reference angle marker based on the light reception signal detected by the light receiving unit being equal to or greater than a signal strength that is prescribed in advance, and
detect the detection angle of the reference rotation angle using the second reference angle marker based on the light reception signal detected by the light receiving unit being less than the signal strength that is prescribed in advance.

9. The optical distance measurement apparatus according to claim 5, wherein:
a shape of the reference angle marker is a geometric figure in a planar view; and
the positional deviation detection apparatus is configured to
determine presence or absence of an abnormality in the optical distance measurement apparatus using changes in a shape of the geometric figure that is detected by the light receiving unit.

10. The optical distance measurement apparatus according to claim 5, wherein:
a number of light receiving elements that are used for detection of the deviation amount by the positional deviation detection apparatus is less than a number of light receiving elements that are used for distance measurement of a target outside the casing.

11. The optical distance measurement apparatus according to claim 2, wherein:
the rotating unit scans the mirror along one direction;
the light emitting unit emits the laser light that has a width that is prescribed in advance in a direction that intersects the one direction; and
the light receiving unit includes a plurality of light receiving elements, and the plurality of light receiving elements are arranged so as to correspond to the width that is prescribed in advance.

12. The optical distance measurement apparatus according to claim 3, wherein:
the rotating unit scans the mirror along one direction;
the light emitting unit emits the laser light that has a width that is prescribed in advance in a direction that intersects the one direction; and
the light receiving unit includes a plurality of light receiving elements, and the plurality of light receiving elements are arranged so as to correspond to the width that is prescribed in advance.

13. The optical distance measurement apparatus according to claim 2, further comprising:
a rotation angle sensor that detects the rotation angle of the mirror; and
a positional deviation detection apparatus that detects a deviation amount between the rotation angle of the mirror and a detection angle of the rotation angle of the mirror that is detected by the rotation angle sensor,
the positional deviation detection apparatus is configured to
control the rotating unit and rotates the mirror by a unit detection angle that is prescribed in advance within an angular range that includes the reference rotation angle,
acquire a light reception signal at every unit detection angle prescribed in advance that is detected by the light receiving unit, and generate at least either of a distribution of the light reception signals or a distribution of distances that are acquired using the light reception signals,
acquire a detection angle of the reference rotation angle using the light reception signal or the distance that corresponds to the reference angle marker in the at least either of the distributions that is generated, and
detect the deviation amount by comparing the acquired detection angle of the reference rotation angle and the reference rotation angle prescribed in advance.

14. The optical distance measurement apparatus according to claim 3, further comprising:
a rotation angle sensor that detects the rotation angle of the mirror; and
a positional deviation detection apparatus that detects a deviation amount between the rotation angle of the mirror and a detection angle of the rotation angle of the mirror that is detected by the rotation angle sensor,
the positional deviation detection apparatus is configured to
control the rotating unit and rotates the mirror by a unit detection angle that is prescribed in advance within an angular range that includes the reference rotation angle,
acquire a light reception signal at every unit detection angle prescribed in advance that is detected by the light receiving unit, and generate at least either of a distribution of the light reception signals or a distribution of distances that are acquired using the light reception signals,
acquire a detection angle of the reference rotation angle using the light reception signal or the distance that corresponds to the reference angle marker in the at least either of the distributions that is generated, and
detect the deviation amount by comparing the acquired detection angle of the reference rotation angle and the reference rotation angle prescribed in advance.

15. The optical distance measurement apparatus according to claim 13, wherein:
the rotation angle sensor is an encoder that acquires an absolute rotation angle of the mirror and a relative rotation angle in relation to the absolute rotation angle.

16. The optical distance measurement apparatus according to claim 14, wherein:
the rotation angle sensor is an encoder that acquires an absolute rotation angle of the mirror and a relative rotation angle in relation to the absolute rotation angle.

17. The optical distance measurement apparatus according to claim 13, wherein:
the reference angle marker includes at least either of
a first reference angle marker that has a reflectance that differs from a reflectance of a material that composes the casing or the window portion, and
a second reference angle marker that is configured by an opening portion that is provided in the casing and a light source unit that emits irradiation light into the casing through the opening portion.

18. The optical distance measurement apparatus according to claim 14, wherein:
the reference angle marker includes at least either of
a first reference angle marker that has a reflectance that differs from a reflectance of a material that composes the casing or the window portion, and
a second reference angle marker that is configured by an opening portion that is provided in the casing and a light source unit that emits irradiation light into the casing through the opening portion.

19. The optical distance measurement apparatus according to claim 13, wherein:
a shape of the reference angle marker is a geometric figure in a planar view; and
the positional deviation detection apparatus is configured to
determine presence or absence of an abnormality in the optical distance measurement apparatus using changes in a shape of the geometric figure that is detected by the light receiving unit.

20. The optical distance measurement apparatus according to claim 14, wherein:
a shape of the reference angle marker is a geometric figure in a planar view; and
the positional deviation detection apparatus is configured to
determine presence or absence of an abnormality in the optical distance measurement apparatus using changes in a shape of the geometric figure that is detected by the light receiving unit.
